(19) United States
(12) Patent Application Publication
(10) Pub. No.: US 2019/0191637 A1
(43) Pub. Date: Jun. 27, 2019

(54) APPARATUS FOR VINEYARD TRELLISING SYSTEMS

(71) Applicant: BIC Enterprises, Visalla, CA (US)

(72) Inventor: Bradley Bickers, Visalia, CA (US)

(21) Appl. No.: 16/231,476

(22) Filed: Dec. 22, 2018

Related U.S. Application Data
(60) Provisional application No. 62/609,736, filed on Dec. 22, 2017.

(51) Int. Cl. A01G 17/06; A01G 9/12; F16B 3/00; F16B 45/00; F16M 13/00; F16M 13/02

(52) U.S. Cl. CPC A01G 17/06; A01G 9/12; F16B 3/00; F16M 2200/028; F16M 13/005; F16M 13/02; F16B 45/00

(57) ABSTRACT

An apparatus for constructing trellis systems, particularly for fruit vines. An apparatus may include a vertical post with a slot for slidably receiving a horizontal crossarm. In certain embodiments, an apparatus may include a vertical post, a horizontal crossarm, and a pair of diagonal crossarms. A vertical post may have slots for slidably receiving a horizontal crossarm and diagonal crossarms. A horizontal crossarm may also have slots for slidably receiving diagonal crossarms. Wire notches may be formed into a vertical post, horizontal crossarm, and/or a diagonal crossarm for attachment to a second apparatus or another stationary object, or for anchoring an apparatus to the ground. The present invention allows for a trellis system which is quickly and easily assembled, and highly durable.

### FIELD OF THE INVENTION

The present invention concerns an apparatus for assembling a trellis system. More specifically, embodiments of the present invention pertain to an apparatus for the attachment of one or more wires for growing vines comprising components that are slidably connected.

### BACKGROUND OF THE INVENTION

Trellis systems are often used to support and manage the growth of vines. They are essential for large vineyards of raisin, table or wine grapes. There are many advantages to using such systems, such as increasing grape quality and productivity. Trellises may also provide advantages during harvest by reducing the amount of labor.

Modern trellis systems utilize a variety of types of materials and wires assembled to form a plurality of configurations. Implementation of a specific type of system is largely dependent on the location, demand, and type of vine. However, conventional trellis systems are often expensive and labor intensive. A trade-off is typically made between cost, material strength, and the amount labor required. For example, some trellises may utilize a wood system comprising a single post and single crossarm. While the amount of time and labor required to assemble such system is minimal, the overall strength, and thus growth capacity, is greatly diminished. On the other hand, other trellis systems may utilize metal (e.g. steel, iron, copper, etc.) for increased strength and durability. However, the assembly of such systems often requires extensive labor due not only to the weight of the materials, but also to the assembly means (i.e., use of multiple screws, clamps, etc.).

It is therefore desirable for trellis apparatuses and systems which are cost-effective, easy to assemble, and able to support the growth of large vines.

### SUMMARY OF THE INVENTION

The embodiments of the present invention relate to an apparatus by which a trellis system is assembled. More specifically, the components of an apparatus are slidably connected to form a support structure by which trellis wire can be secured to other apparatuses or stationary structures for the purpose of growing fruit vines. As will be described in the exemplary embodiments, the features of the present invention allow for a trellis system that is quickly assembled, highly durable, and able to accommodate large vine capacities.

In some embodiments, the present invention may include at least one vertical post and at least one horizontal crossarm constructed from rolled steel. A portion of a horizontal crossarm may be bowed, angled, or arched. A vertical post can have at least one slot for slidably receiving and securing a horizontal crossarm in a substantially orthogonal position thereto. In certain embodiments, a vertical post and horizontal crossarm may be formed into rectangular tubes. A vertical post may also comprise a strut channel and a horizontal crossarm may comprise a strut/hat channel combination. At least one slot may be shaped in accordance with the cross-sectional shape of a horizontal crossarm. A horizontal crossarm can include at least one wire notch for the securing of at least one wire to a second apparatus or other stationary object. A wire notch may be circular, square, or any other shape, but preferably oval shaped.

In other embodiments of the present invention, an apparatus may include at least one vertical post, at least one horizontal crossarm, and at least one diagonal crossarm, all of which may be constructed from rolled steel. A vertical post may include slots for slidably receiving and securing a horizontal crossarm and a diagonal crossarm, where a horizontal crossarm is received substantially orthogonal to a vertical post. A horizontal crossarm may include at least one slot for slidably receiving and securing at least one diagonal crossarm. At least one slot may be shaped in accordance with the cross-sectional shape of a horizontal crossarm and/or diagonal crossarm. A horizontal crossarm may include slots on an upper and lower face thereof, which may be offset from one another to receive a diagonal crossarm at an angle. In some embodiments, the acute angle formed between a vertical post and a diagonal crossarm can be between 40° and 60°, but preferably about 53°. In certain embodiments, a vertical post, horizontal crossarm, and/or diagonal crossarm may include at least one wire notch for the securing of at least one wire to a second apparatus or other stationary object. A wire notch may be circular, square, or any other shape, but preferably oval shaped.

In some embodiments of the invention, a vertical post, a horizontal crossarm, and a diagonal crossarm may be formed into rectangular tubes. In one aspect, a vertical post may comprise a strut channel, a horizontal crossarm may comprise a J-channel, and a diagonal crossarm may comprise a J-channel with an inwardly directed leg. In other aspects, a vertical post may comprise a C-channel, a horizontal crossarm may comprise a U-channel, and the tubing of a diagonal crossarm may be open seam. It is to be appreciated, however, that a vertical post and/or crossarm may be formed into a plurality of shapes and may comprise a plurality of channel types.

In certain embodiments of the present invention, a vertical post, a horizontal crossarm, and a diagonal crossarm may have at least one flange or protruding edge. A flange or protruding edge may include at least one wire notch for the securing of at least one wire to a second apparatus or other stationary object. A wire notch may be circular, square, or any other shape, but preferably oval shaped.

It is to be appreciated that the exemplary embodiments described do not limit the scope of the present invention. For example, and without limitation, a vertical post, horizontal crossarm, and/or diagonal crossarm may be formed into a plurality of tube shapes, such as square, circular, or diamond. It is further to be appreciated that the present invention may include a combination of posts and crossarms of varying tube shapes. Similarly, the components of the apparatuses may include a plurality of channel types, such as, but not limited to, a box-channel, hat-channel, or Z-channel, or combination or variation thereof. Furthermore, one or more wire notches may be formed into a plurality of shapes and may have wire securing features (e.g., protrusions or clamps to hold wire within a notch). The components of the present invention may also have a variety of types of flanges that may be bent inwardly or outwardly, folded or hemmed, or otherwise shaped.

### BRIEF DESCRIPTION OF THE DRAWINGS

FIG. 1 is a front view illustrating an exemplary trellis apparatus in accordance with some embodiments of the present invention.

FIG. 2 is a partial perspective view of an exemplary vertical post for use with the apparatus illustrated in FIG. 1.

FIG. 3 is a cross-sectional view of the vertical post illustrated in FIG. 2.

FIG. 4 is a perspective view of an exemplary horizontal crossarm for use with the apparatus illustrated in FIG. 1.

FIG. 5 is a cross-sectional view of the horizontal crossarm illustrated in FIG. 4.

FIG. 6 is a top view of the horizontal crossarm illustrated in FIG. 4 illustrating the orientation of an upper slot relative to a lower slot (partially visible).

FIG. 7 is a perspective view of an exemplary diagonal crossarm for use with the apparatus illustrated in FIG. 1.

FIG. 8 is an enlarged view of detail portion A of FIG. 7.

FIG. 9 is a cross-sectional view of the diagonal crossarm illustrated in FIG. 7.

FIG. 10 is a front perspective view illustrating an exemplary trellis apparatus in accordance with some embodiments of the present invention.

FIG. 11 is a partial perspective view of an exemplary vertical post for use with the apparatus illustrated in FIG. 10.

FIG. 12 is a cross-sectional view of the vertical post illustrated in FIG. 11.

FIG. 13 is a front view of an exemplary horizontal crossarm for use with the apparatus illustrated in FIG. 10.

FIG. 14 is a partial top view of the horizontal crossarm illustrated in FIG. 13.

FIG. 15 is a cross-sectional view of the horizontal crossarm illustrated in FIG. 13.

FIG. 16 is a front view of an exemplary diagonal crossarm for use with the apparatus illustrated in FIG. 10.

FIG. 17 is a cross-sectional view of the diagonal crossarm illustrated in FIG. 16.

FIG. 18 is a front perspective view illustrating an exemplary trellis apparatus in accordance with some embodiments of the present invention.

FIG. 19 is a partial perspective view of an exemplary vertical post for use with the apparatus illustrated in FIG. 18.

FIG. 20 is a cross-sectional view of the vertical post illustrated in FIG. 19.

FIG. 21 is a front view of an exemplary horizontal crossarm for use with the apparatus illustrated in FIG. 18.

FIG. 22 is an enlarged perspective view of detail portion B of FIG. 21.

FIG. 23 is a cross-sectional view of the horizontal crossarm illustrated in FIG. 21.

FIG. 24A is a cross-sectional view of an exemplary diagonal crossarm in accordance with some embodiments of the present invention.

FIG. 24B is a cross-sectional view of an exemplary diagonal crossarm in accordance with some embodiments of the present invention.

FIG. 25 is a cross-sectional view of an exemplary horizontal crossarm in accordance with some embodiments of the present invention.

### DETAILED DESCRIPTION OF THE PREFERRED EMBODIMENTS

The invention, in its various aspects, will be explained in greater detail below. While the invention will be described in conjunction with several exemplary embodiments, the exemplary embodiments themselves do not limit the scope of the invention. Similarly, the exemplary illustrations in the accompanying drawings, where like elements have like numerals, do not limit the scope of the exemplary embodiments and/or invention. Rather the invention, as defined by the exemplary claims, may cover alternatives, modifications, and/or equivalents of the exemplary embodiments.

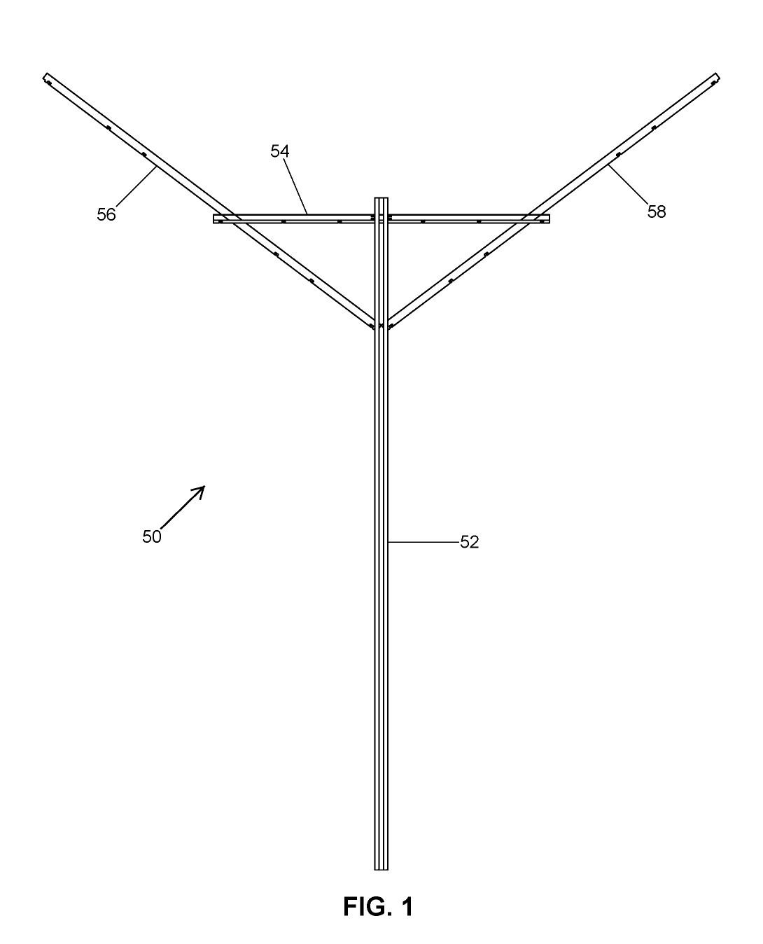

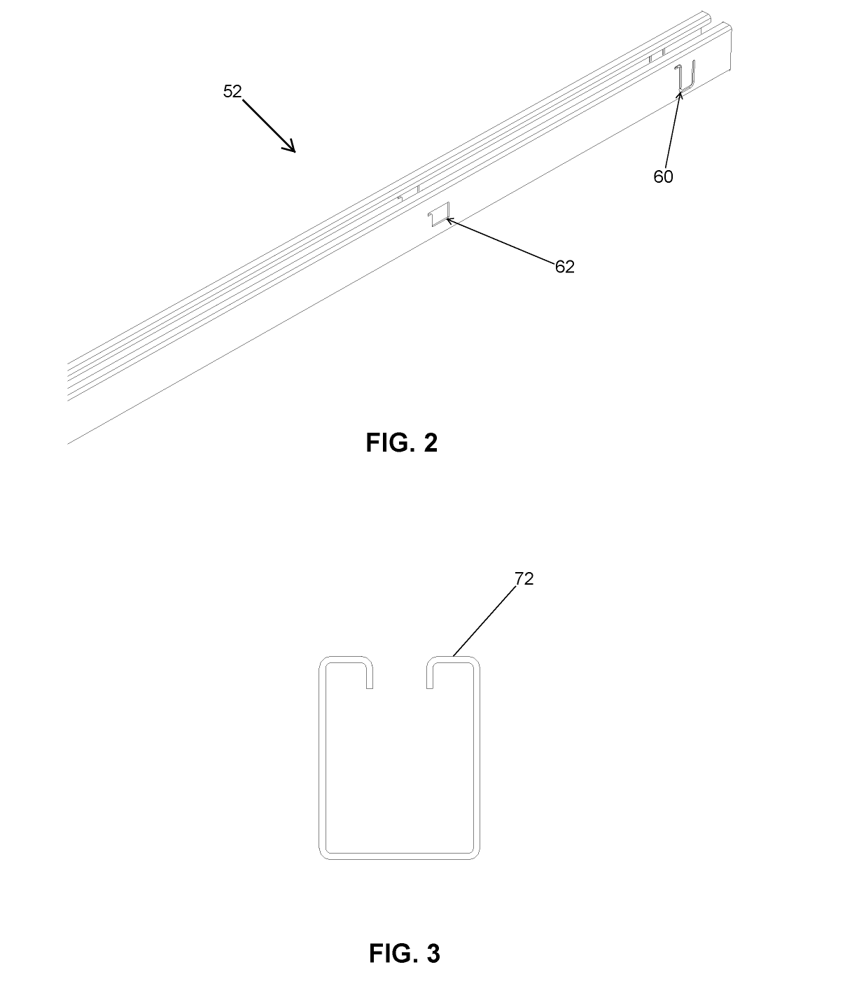

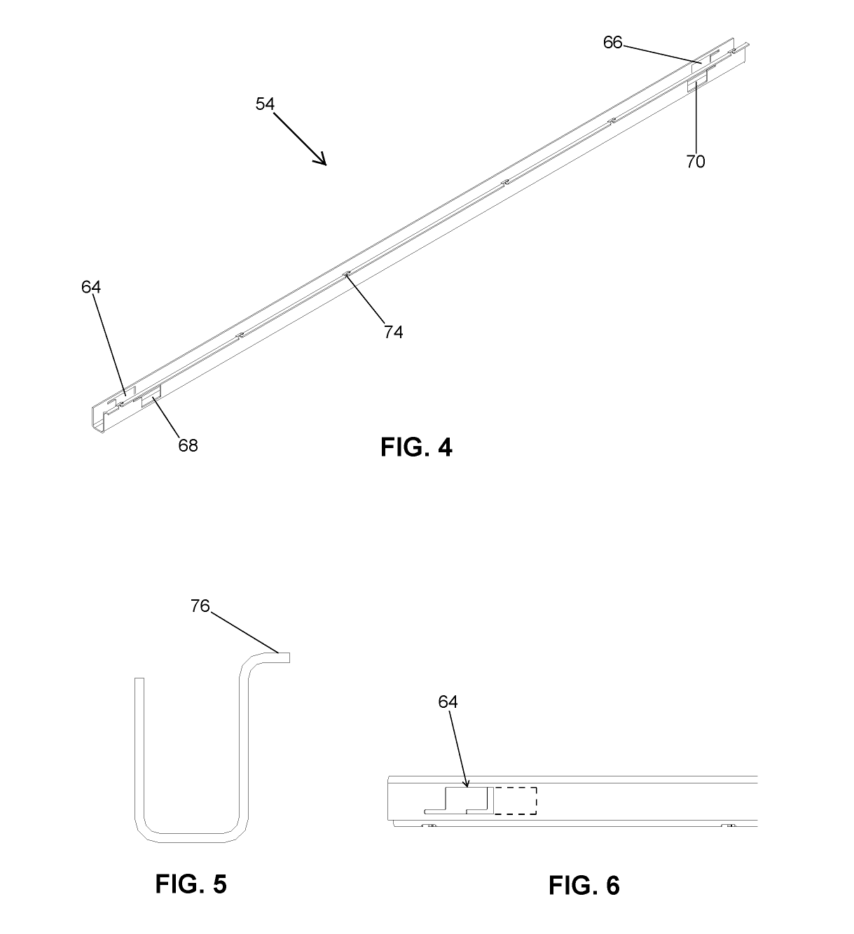

Referring, generally, to FIGS. 1-9, a preferred embodiment of the present invention may consist of four components. Trellis apparatus 50 may include a vertical post 52, a horizontal crossarm 54, a first diagonal crossarm 56, and a second diagonal crossarm 58. In preferred embodiments, diagonal crossarms 56 and 58 are identical such that they can be interchanged. However in other embodiments, they may not be identical such that each diagonal crossarm 56 and 58 can only be used on a particular side of horizontal crossarm 54. Horizontal crossarm 54 may be slidably received at a horizontal crossarm receiving slot 60 near the top of, and orthogonal to, vertical post 52 (see, e.g., FIGS. 1 and 2). First diagonal crossarm 56 may be slidably received through a first upper slot 64 and a first lower slot 68 on an upper and lower face of horizontal crossarm 54, respectively. Similarly, second diagonal crossarm 58 may be slidably received through a second upper slot 66 and a second lower slot 70 on an upper and lower face of horizontal crossarm 54, respectively (see, e.g., FIG. 4). First and second upper slots 64 and 66 and first and second lower slots 68 and 70 of horizontal crossarm 54 may be offset from each other in order to receive first and second diagonal crossarms 56 and 58 at an angle, as best seen in FIGS. 4 and 6. First diagonal crossarm 56 and second diagonal crossarm 58 may be slidably received by vertical post 52 at diagonal crossarm slot 62 (see, e.g., FIG. 2).

When secured, the acute angle formed between a vertical post and a diagonal crossarm may be between 40° and 60°, but preferably about 53°. It is to be appreciated that the angle formed between the vertical post and the diagonal crossarm is relative to (i) the distance between diagonal crossarm slot 62 and horizontal crossarm receiving slot 60, (ii) the lateral distance between the point of engagement of horizontal crossarm 54 and vertical post 52 (through horizontal crossarm receiving slot 60) and the first/second upper/lower slots (64, 68, 66, 70), and (iii) the lateral offset between the first/second upper and lower slots (i.e., the offset illustrated in FIG. 6).

First upper crossarm slot 64, first lower crossarm slot 68, second upper crossarm slot 66, and second lower crossarm slot 70 may comprise a shape in accordance with the cross-sectional shapes of first and second diagonal crossarms 56 and 58 (i.e., the shape formed by the outer surface of the cross section when projected at the angle formed between the vertical post and the diagonal crossarm). Similarly, diagonal crossarm slot 62 may comprise a shape in accordance with the cross-sectional shapes of first and second diagonal crossarms 56 and 58. Horizontal crossarm receiving slot 60 may comprise a shape in accordance with the cross-sectional shape of horizontal crossarm 54 (see, e.g., FIGS. 2, 5-6, and 9).

Referring, specifically, to FIGS. 2 and 3, in preferred embodiments, vertical post 52 can be shaped as a C-channel with legs 72. Legs 72 may each have inwardly folded flanges. As illustrated in FIG. 5, in preferred embodiments, horizontal crossarm 54 may be shaped as a 4. Horizontal crossarm 54 may also include a flange 76 protruding from the front end of a lower side of horizontal crossarm 54. As illustrated in FIG. 9, in preferred embodiments, first and second diagonal crossarms 56 and 58 may be shaped as open seam rectangular tubes and may each have a protruding edge 78 directed downward from the front side of each crossarm. It is to be appreciated that, in some embodiments of the present invention, each the vertical post, the horizontal crossarm, and the diagonal crossarms may have other shapes.

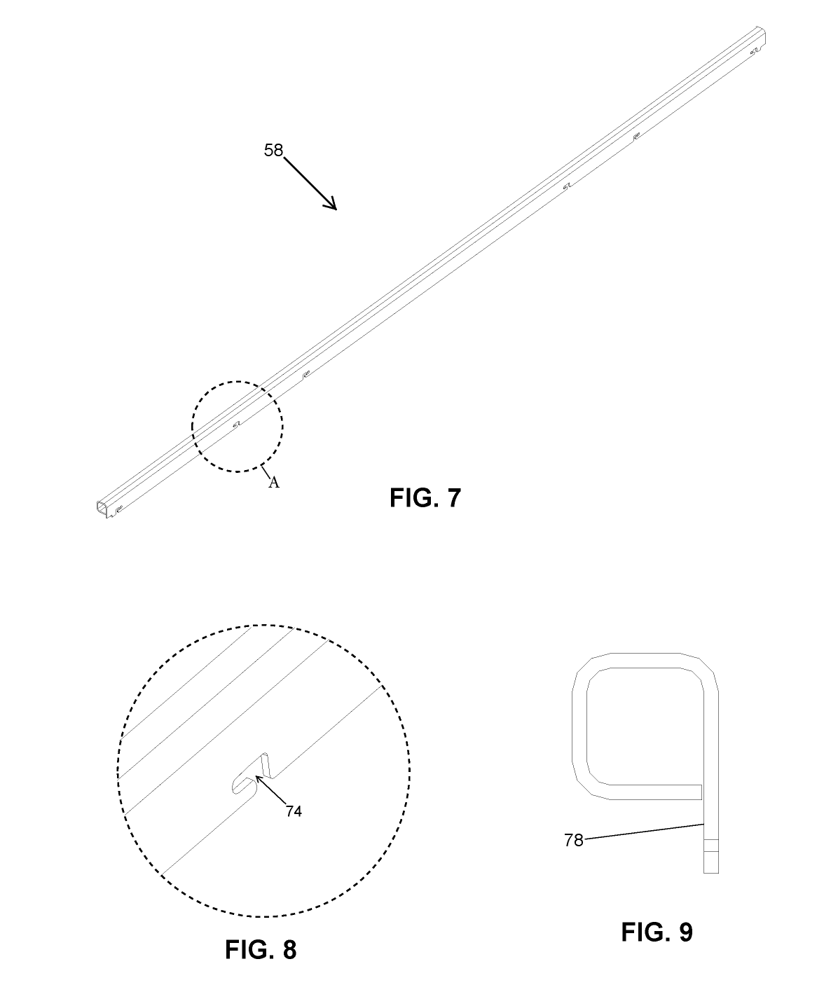

As illustrated in FIG. 4, one or more wire notches 74 may be located along flange 76 of horizontal crossarm 54. In some embodiments, the wire notches 74 may be between near the distal ends to near a midpoint of horizontal crossarm 54 (see, e.g., FIG. 4). As illustrated in FIGS. 7 and 8, one or more wire notches 74 may also be located along protruding edge 78 of a diagonal crossarm 58 (and similarly diagonal crossarm 56). In some embodiments, wire notches 74 may be between near a distal end of diagonal crossarm 58 (or diagonal crossarm 56) and near the intersections with horizontal crossarm 54 and vertical post 52 (i.e., near the receiving slots). Wire notches 74 may be used to attach and secure wire from trellis apparatus 50 to other trellis apparatuses and/or other stationary objects, thus forming a wire trellis system for supporting vines. Though not illustrated, to anchor an apparatus to the ground, a vertical post may also have notches, holes, or other means by which wire, screws, and/or bolts can be secured.

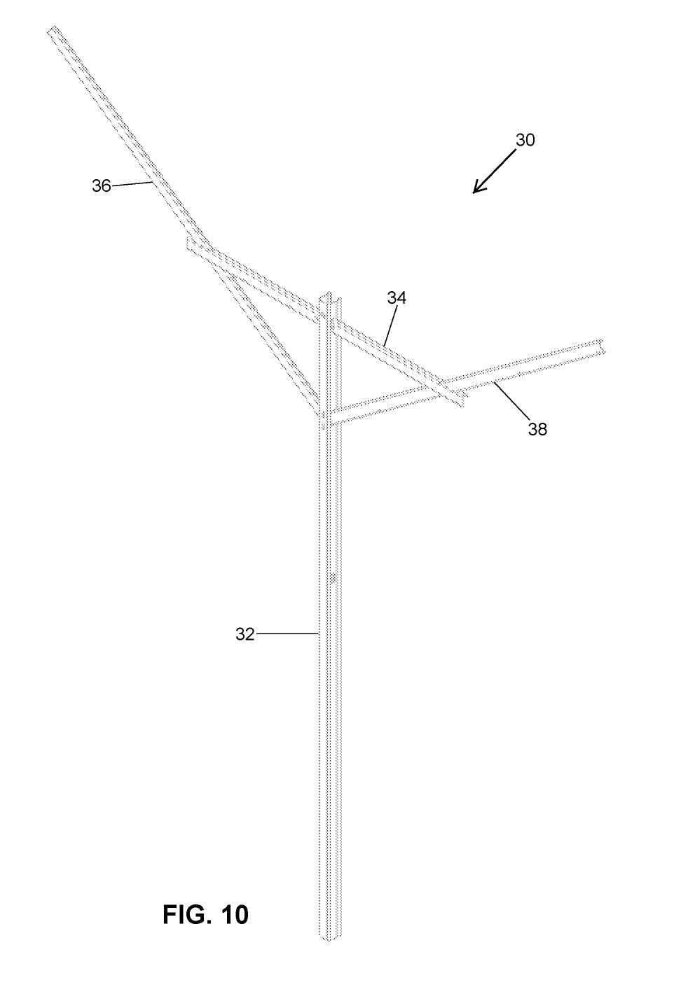

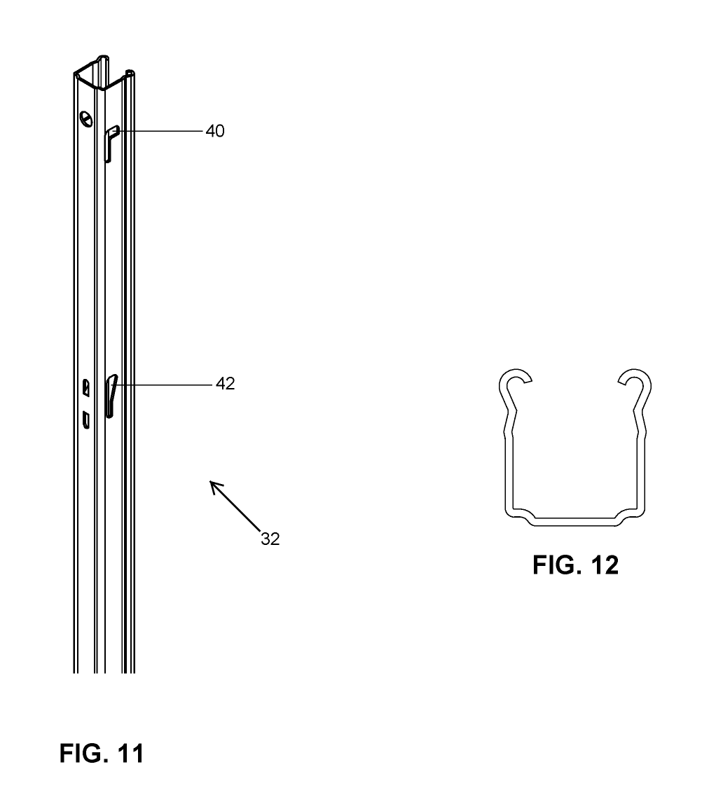

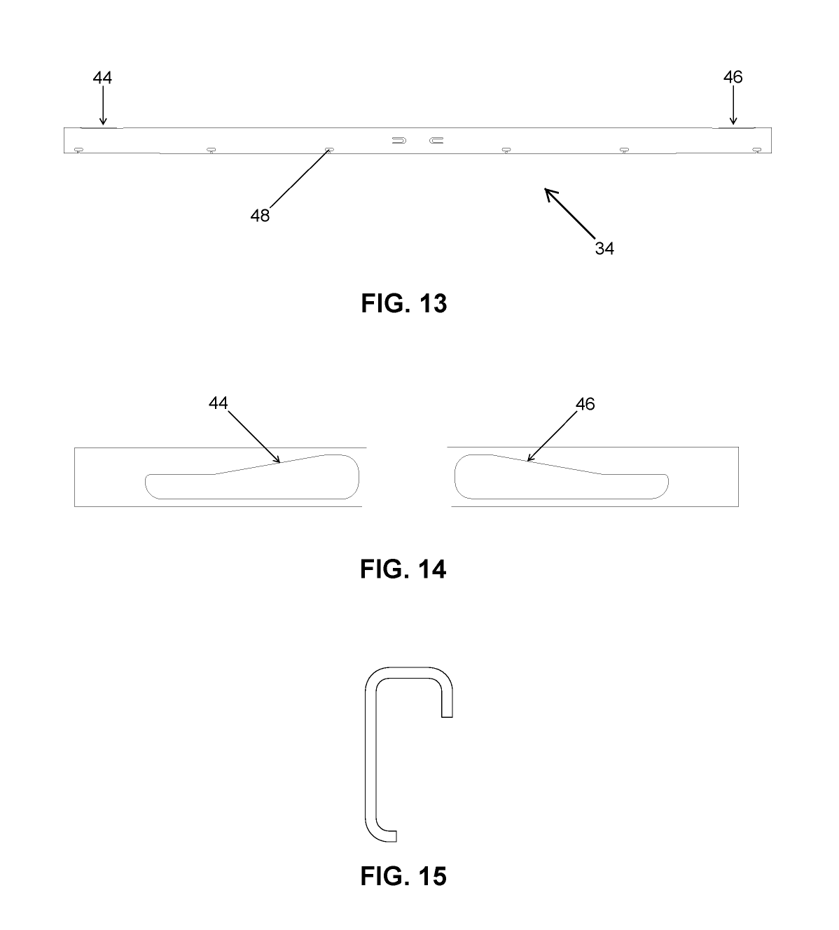

Referring, generally, now to FIGS. 10-17, another embodiment of the present invention can be seen which may consist of four components. Trellis apparatus 30 may include a vertical post 32, horizontal crossarm 34, first diagonal crossarm 36, and second diagonal crossarm 38. As best seen in FIG. 11, vertical post 32 may have a horizontal receiving slot 40 for slidably receiving and securing horizontal crossarm 34 near the top of, and orthogonal to, vertical post 32. Vertical post 32 may also have a diagonal crossarm receiving slot 42 below horizontal receiving slot 40 for slidably receiving and securing first and second diagonal crossarms 36 and 38. As shown in FIGS. 13 and 14, horizontal crossarm 34 may include a first receiving slot 44 and second receiving slot 46 on its upper face for slidably receiving and securing first diagonal crossarm 36 and second diagonal crossarm 38, respectively.

As best shown in FIG. 12, in some embodiments, vertical post 32 may comprise a strut channel with rounded legs. As seen in FIG. 15, in some embodiments, horizontal crossarm 34 may comprise a J-channel. In some embodiments, first and second diagonal crossarms 36 and 38 may also comprise J-channels and may have upper legs with inwardly folded flanges, as shown in FIG. 17. As above, it is to be appreciated that the vertical post, the horizontal crossarm, and the diagonal crossarms may have other shapes. Similar to the exemplary system illustrated in FIG. 1, the shape of horizontal receiving slot 40 may be in accordance with the cross-sectional shape of horizontal crossarm 34, and the shapes of first receiving slot 44, second receiving slot 46, and diagonal crossarm receiving slot 42 may be in accordance with the cross-sectional shape of first diagonal crossarm 36 and second diagonal crossarm 38, projected at an angle formed between the vertical post 32 and the first diagonal crossarm 36 and the second diagonal crossarm 38.

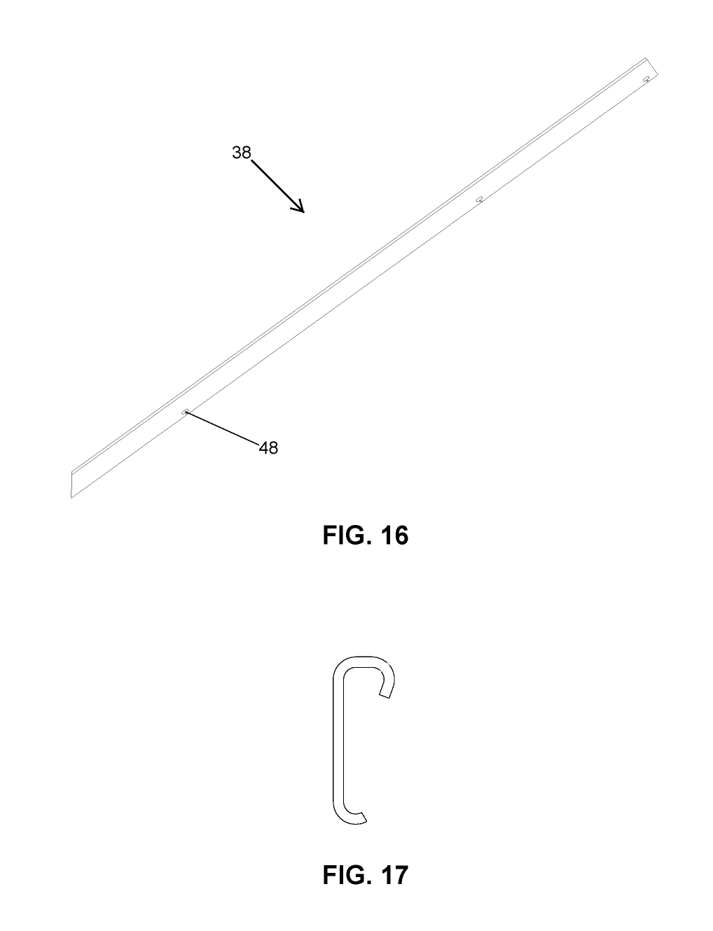

As best seen in FIG. 13, horizontal crossarm 34 may have one or more wire notches 48 located along a lower edge thereof. Wire notches 48 may also be located along a lower edge of first and second diagonal crossarms 36 and 38 (see, e.g., FIG. 16). Wire notches 48 may be used to attach and secure wire from trellis apparatus 30 to other trellis apparatuses and/or other stationary objects, thus forming a trellis system for supporting vines. To anchor an apparatus to the ground, though not illustrated, the vertical post may also have notches, holes, or other means by which wire, screws, and/or bolts can be secured.

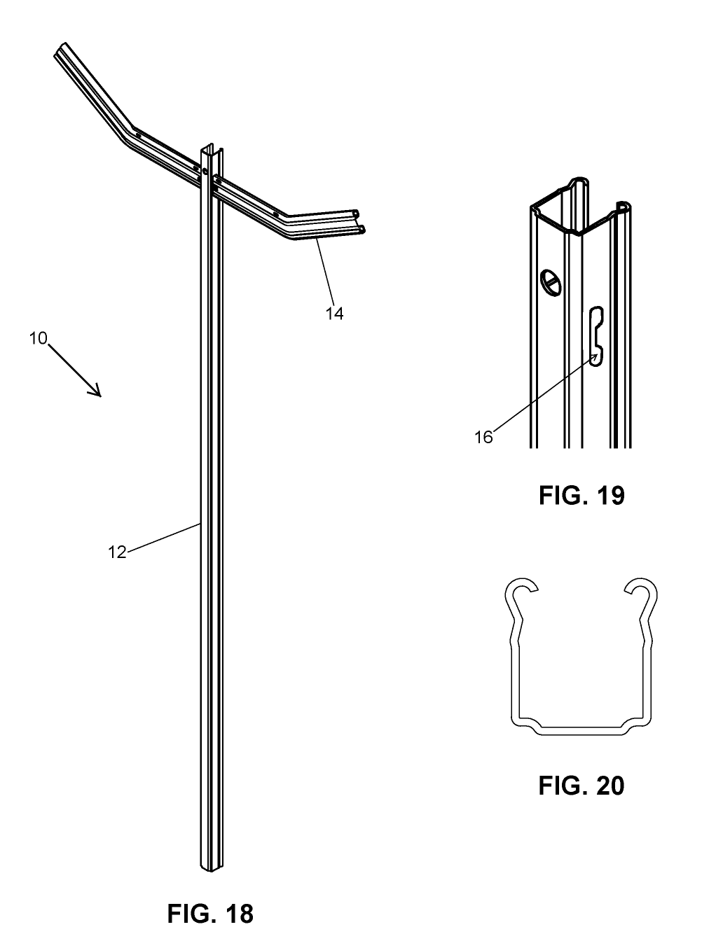

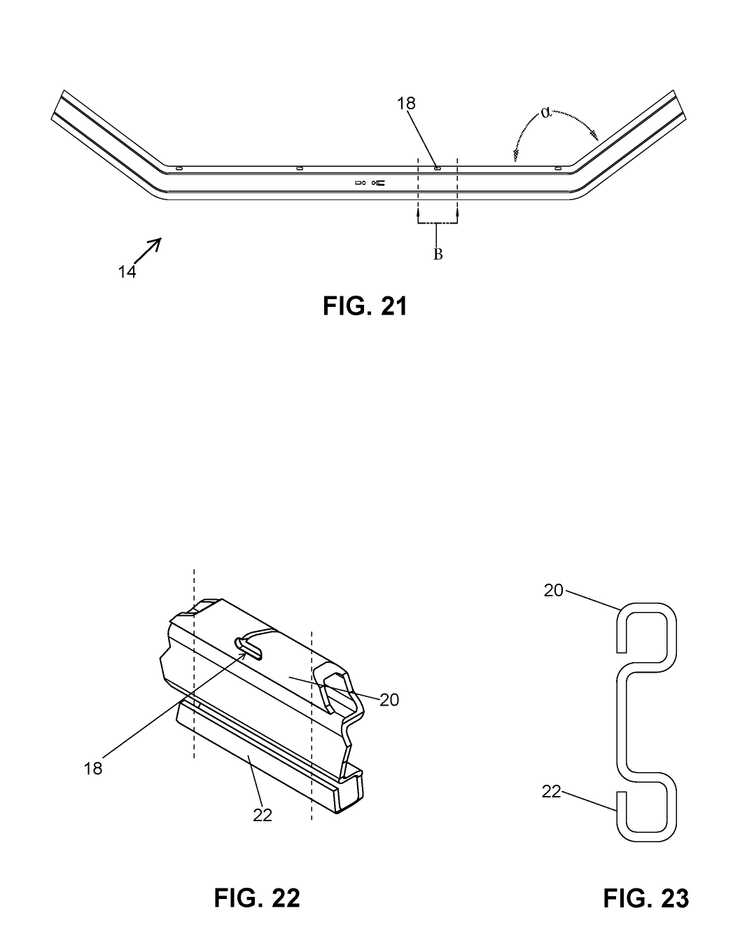

Referring, generally, to FIGS. 18-23, one embodiment of the present invention can be seen which may consist of two components. Trellis apparatus 10 may include a vertical post 12 and a horizontal crossarm 14. Vertical post 12 may have a crossarm receiving slot 16 near an upper end thereof for slidably receiving horizontal crossarm 14. As best viewed in FIG. 21, the lateral portions of horizontal crossarm 14 may be bowed at an angle α, with respect to the medial, level portion of horizontal crossarm 14. In preferred embodiments, the angle α may be 150°. Vertical post 12 may comprise a strut channel with rounded legs (as illustrated in FIG. 20) and horizontal crossarm 14 may comprise a strut/hat channel combination (as illustrated in FIG. 23). Crossarm receiving slot 16 may be shaped in accordance with the cross-sectional shape of horizontal crossarm 14 (see, e.g., FIGS. 19-20 and 23).

As seen in FIGS. 21 and 22, wire notches 18 may be located along an edge of horizontal crossarm 14, and in preferably, in the medial portion of horizontal crossarm 14. More specifically, wire notches 18 may be formed into an upper flange 20 or lower flange 22 of the channel of horizontal crossarm 14. Wire notches 18 may be used to attach and secure wire from trellis apparatus 10 to other trellis apparatuses and/or other stationary objects, thus forming the trellis system supporting the vines. To anchor an apparatus to the ground, although not illustrated, the vertical post may also have notches, holes, or other means by which wire, screws, and/or bolts can be secured.

The present invention provides apparatuses for constructing trellis that are cost effective and easy to install. With reference particularly to the exemplary illustrations of FIGS. 1-9, the system can be constructed and secured by simply sliding the various components into place. For example, the vertical post can be installed in the ground. Thereafter, the horizontal crossarm can be slid through the horizontal crossarm receiving slot in the vertical post. In embodiments comprising one or more diagonal crossarms, they can thereafter be slid through the one or more slots in the horizontal crossarms and then through the diagonal crossarm slot in the vertical post. In some embodiments, the horizontal crossarm can have one or more medially positioned retention tabs (as illustrated in FIGS. 13 and 21) which can serve to secure the horizontal crossarm relative to the vertical post. In other embodiments, the horizontal crossarm can be secured to the vertical post with a single bolt and nut. Similarly, the lower distal ends of the diagonal crossarms can be secured to the vertical post with a single bolt and nut.

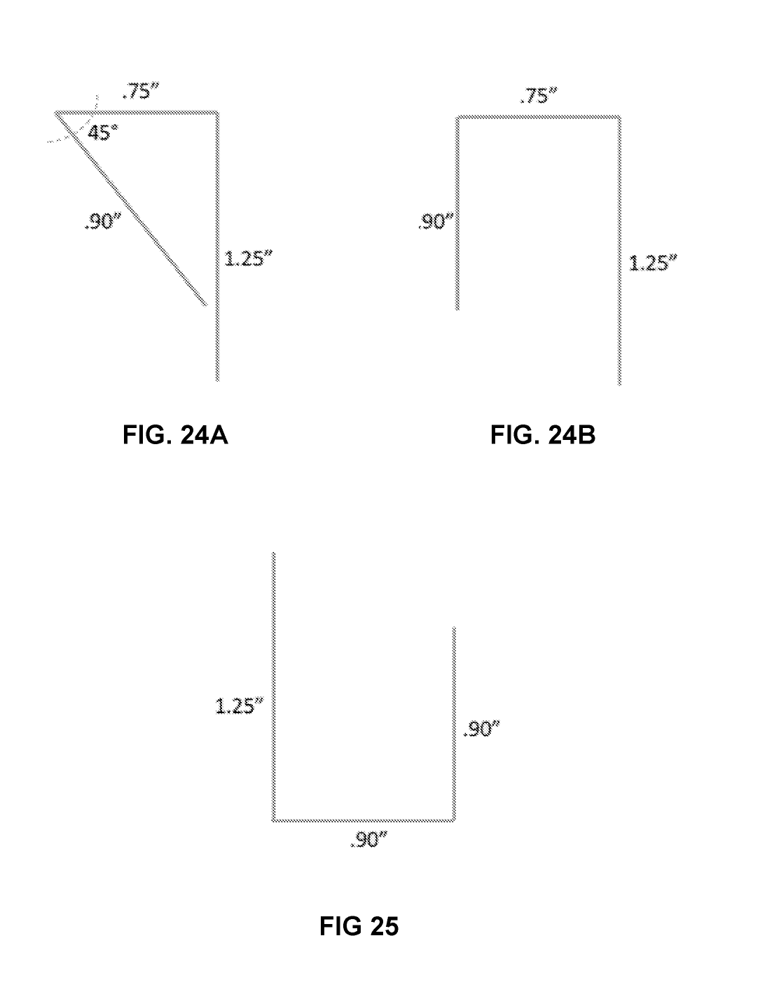

The aforementioned exemplary angles, positioning and shapes of the slots, and the shapes and channel types of the crossarms and posts were chosen for rigidity and strength and to complement the various components of the present invention. With reference to FIG. 24A, a preferred diagonal crossarm can have a triangular shape with an extended protruding edge. In other preferred embodiments, and with reference to FIG. 24B, a diagonal crossarm can have a U-channel with an extending protruding edge. In a preferred embodiment, and with reference to FIG. 25, a horizontal crossarm can have a U-channel with an extending parallel flange. However, it is to be appreciated that the slots, posts, and crossarms may be shaped in accordance with one's desired specifications and configurations. Likewise, the exemplary angles described and the positioning of the slots may also vary depending on one's desired configurations.

The foregoing descriptions of specific embodiments of the present invention have been presented for purposes of illustration and description. They are not intended to be exhaustive or to limit the invention to the precise forms disclosed, and many modifications and variations are possible in light of the above teachings. The embodiments were chosen and described in order to best explain the principles of the invention and its practical application, to thereby enable others skilled in the art to best utilize the invention and various embodiments with various modifications as are suited to the particular use contemplated. It is to be understood that variations and modifications of the present invention may be made without departing from the scope thereof. It is to be appreciated that the features disclosed herein may be used different combinations and permutations with each other, all falling within the scope of the present invention. It is also to be understood that the present invention is not to be limited by the specific embodiments disclosed herein, but only in accordance with the appended claims when read in light of the foregoing specification.

What is claimed is:

1. An apparatus for assembling a trellis comprising:
a) a vertical post;
b) a horizontal crossarm;
wherein said vertical post comprises a slot for slidably receiving and securing said horizontal crossarm; and
wherein said vertical post and said horizontal crossarm comprise rolled steel.

2. The apparatus of claim 1, wherein said slot of said vertical post is shaped according to a cross section of said at least one horizontal crossarm.

3. The apparatus of claim 2, wherein said vertical post and said horizontal crossarm are formed as open seam tubes.

4. The apparatus of claim 3, wherein said horizontal crossarm further comprises at least one wire notch for receiving and securing therein at least one wire.

5. An apparatus for assembling a trellis comprising:
a) a vertical post;
b) a horizontal crossarm; and
c) at least one diagonal crossarm;
wherein said vertical post, said horizontal crossarm, and said at least one diagonal crossarm comprise rolled steel,
wherein said vertical post comprises a first slot for slidably receiving said horizontal crossarm,
wherein said horizontal crossarm comprises at least one slot for slidably receiving said at least one diagonal crossarm, and
wherein said vertical post comprises a second slot for slidably receiving said at least one diagonal crossarm.

6. The apparatus of claim 5, wherein said at least one diagonal crossarm comprises a first diagonal crossarm and a second diagonal crossarm.

7. The apparatus of claim 5, wherein said horizontal crossarm comprises at least one retention tab for securing said horizontal crossarm to said vertical post.

8. The apparatus of claim 5, wherein said at least one slot of said horizontal crossarm comprises a first upper slot, a second upper slot, a first lower slot, and a second lower slot,
wherein said first diagonal crossarm is received through said first upper slot and said first lower slot, and
wherein said second diagonal crossarm is received through said second upper slot and said second lower slot.

9. The apparatus of claim 8, wherein said first upper slot and said first lower slot of said horizontal crossarm comprise a shape corresponding to a cross sectional shape of said first diagonal crossarm, and wherein said second upper slot and said second lower slot of said horizontal crossarm comprise a shape corresponding to a cross sectional shape of said second diagonal crossarm.

10. The apparatus of claim 5, wherein said first slot of said vertical post comprises a shape corresponding to a cross sectional shape of said horizontal crossarm, and wherein said second slot of said vertical post comprises a shape corresponding to a cross sectional shape of said at least one diagonal crossarm.

11. The apparatus of claim 5, wherein said vertical post, said horizontal crossarm, and said first and second diagonal crossarms are formed as open seam tubes.

12. The apparatus of claim 5, wherein said vertical post comprises a strut channel and wherein said horizontal crossarm, said first diagonal crossarm, and said second diagonal crossarm comprise J-channels.

13. The apparatus of claim 5, wherein said horizontal crossarm comprises at least one wire notch for receiving and securing therein at least one wire.

14. The apparatus of claim 13, wherein each said at least one diagonal crossarm comprise at least one wire notch for receiving and securing therein at least one wire.

15. An apparatus for assembling a trellis comprising:
a) a vertical post;
b) a horizontal crossarm; and
c) a first diagonal crossarm and a second diagonal crossarm, each said crossarm having the same shape;
wherein said vertical post, said horizontal crossarm, said first diagonal crossarm, and said second diagonal crossarm comprise rolled steel;
wherein said vertical post comprises a first slot for slidably receiving said horizontal crossarm and a second slot for slidably receiving said first diagonal crossarm and said second diagonal crossarm;
wherein said horizontal crossarm comprises a plurality of slots for slidably receiving said first diagonal crossarm and said second diagonal crossarm;
wherein said horizontal crossarm comprises at least one retention tab for securing said horizontal crossarm to said vertical post.

16. The apparatus of claim 15, wherein said vertical post comprises a C-channel with inwardly folded flanges;
wherein said horizontal crossarm comprises a U-channel; and
wherein said first diagonal crossarm and said second diagonal crossarm comprises a triangular cross sectional shape.

17. The apparatus of claim 16, wherein said horizontal crossarm further comprises a flange and wherein said first diagonal crossarm and said second diagonal crossarm each further comprise a protruding edge.

18. The apparatus of claim 17, wherein said flange of said horizontal crossarm and said protruding edges of each of said first diagonal crossarm and said second diagonal crossarm comprise at least one wire notch, each said wire notch for receiving and securing therein at least one wire.

19. A method of assembling a trellis comprising the steps of:
a) securing a first vertical post and a second vertical post in the ground; and
b) sliding a first horizontal crossarm through a first slot of said first vertical post, and sliding a second horizontal crossarm through a first slot of said second vertical post, each said horizontal crossarm comprising at least one retention tab securing said horizontal crossarm to said vertical post.

20. The method of claim 19, further comprising the steps of:
a) sliding a first diagonal crossarm through a first slot of said first horizontal crossarm;
b) sliding a second diagonal crossarm through a second slot of said first horizontal crossarm;
c) sliding a third diagonal crossarm through a first slot of said second horizontal crossarm; and
d) sliding a fourth diagonal crossarm through a second slot of said second horizontal crossarm.

21. The method of claim 20, further comprising the steps of:
a) sliding each said first diagonal crossarm and said second diagonal crossarm through a second slot of said first vertical post; and
b) sliding each said third diagonal crossarm and said second diagonal crossarm through a second slot of said second vertical post.

22. The method of claim 22, further comprising the steps of:
a) positioning a first wire through a wire notch in said first diagonal crossarm and a wire notch in said third diagonal crossarm; and
b) positioning a second wire through a wire notch in said second diagonal crossarm and a wire notch in said fourth diagonal crossarm.

23. The method of claim 19, further comprising the steps of
a) securing said first horizontal crossarm to said first vertical post by a first bolt; and
b) securing said second horizontal crossarm to said second vertical post by a second bolt.
